(19) United States
(12) Patent Application Publication
(10) Pub. No.: US 2013/0031790 A1
(43) Pub. Date: Feb. 7, 2013

(54) Multi-Blade Hand Held Knife for Kitchen Use

(71) Applicant: Lisa Lambert, Newbury Park, CA (US)

(72) Inventor: Lisa Lambert, Newbury Park, CA (US)

(21) Appl. No.: 13/568,080

(22) Filed: Aug. 6, 2012

Related U.S. Application Data
(60) Provisional application No. 61/515,886, filed on Aug. 6, 2011.

(51) Int. Cl. B26B 3/04

(52) U.S. Cl. 30/304

(57) ABSTRACT

A hand held multi-bladed knife is provided for kitchen use. Specifically, a hand held knife is provided having five generally parallel precisely curved blades extending from a handle. The blades have a sharpened edge along their length leading to a point and an opposite, unsharpened blade back. The blades are equally distanced in relation to one another so as to allow the user to make uniform consistent slices of various food items in one quick and easy motion and to allow the user to mince, dice or chop many different food items as well. Each of the five blades has a tang extending in a direction away from the point of the blades and which are ultimately interconnected together and enclosed within the handle of the knife.

### RELATED PATENT APPLICATIONS

This application relates to and claims priority to and benefit of U.S. Provisional Application No. 61/515,886, filed Aug. 6, 2011, also incorporated in its entirety by reference herein.

### BACKGROUND OF THE INVENTION

Knives and other cutlery devices are well known and are provided in many different sizes and shapes for particular uses. In most households and professional food service kitchens, a typical fixed blade knife is generally used to cut food products intended for use in the preparation of salads and other dishes. A typical fixed blade knife has a blade portion at one end and a handle at an opposite end. The blade usually has one sharpened edge along its length and an opposite unsharpened edge referred to as a back of the blade. An extension of the blade, referred to as the tang, extends into the handle portion and is usually surrounded by or encased in a handle piece or pieces to be grasped by a user. Operationally, the cutting and slicing process associated with of use of such knives is generally a repetitive operation requiring one cut for each slice.

Currently, there are usually multiple knives or other cutlery devices needed in order to perform the chopping, slicing or dicing of the wide variety of food items commonly used by the consumers or chefs in their daily food preparation. For example, boiled eggs require one type of slicer, herbs require a smaller type of chopper, and various fruits and vegetables require different knives for effective slicing. There is a need for a cutlery device that can perform all such tasks. The present invention provides a cutlery device that will mince, slice, dice and chop in one quick and easy motion, eliminating the need for multiple kitchen utensils.

### SUMMARY OF THE INVENTION

The present invention relates to a hand held multi-bladed knife for kitchen use. Specifically, a five-blade hand held knife is provided comprising a handle and five generally parallel precisely curved blades extending from the handle; wherein the blades have a curved sharpened edge along their length leading to a point and an opposite, unsharpened blade back; wherein the blades are equally distanced as relates to one another; and wherein the handle includes a plurality of tangs contained therein, said tangs interconnected together at forward, center and rearward portions of the tangs. The unique blade design, with its precisely defined curvature along the sharpened edge of the blade and its defined curvature along the back of the blade, allows the user to make uniform consistent slices of various food items in one quick and easy motion and also allows the user to place a finger(s) on the back of the blade to comfortably apply pressure on the back of the blade to facilitate mincing, slicing, dicing and chopping when desired.

The present invention will be further exemplified and described in detail by FIGS. 1-4 and the disclosure below. The drawings are not intended to limit the scope of the invention but only to clarify and exemplify a preferred embodiment of it.

### BRIEF DESCRIPTION OF THE DRAWINGS

FIG. 1 is a top perspective view of a knife embodying the features of the present invention.

FIG. 2 is a top perspective view looking at the bottom of a knife embodying the features of the present invention, with a particular focus on the blade portion and sharpened blade edges of the knife.

FIG. 3 is a top sectional view of a knife embodying the features of the present invention, with a particular focus on the plurality of handle components and handle assembly.

FIG. 4 is a side perspective view of a knife embodying the features of the present invention.

### DETAILED DESCRIPTION OF THE PREFERRED EMBODIMENTS

The preferred knife of the present invention generally comprises a blade portion and a handle portion which are formed using five “blade units” and a handle piece or pieces as described below.

A “blade unit” will comprise 1) a curved blade portion which has a length defined by the distance between the pointed tip of the blade and the heal of the blade, and which ultimately extends from the handle portion of the knife; and 2) an extension of the curved blade portion, referred to as the tang, which begins at the heal of the blade and extends in a direction away from the pointed tip of the blade to the butt end of the knife, and which is ultimately surrounded by or encased in a handle piece or pieces to form the handle portion of the knife. These blade units will be manufactured from a solid piece of stainless steel that is cut or hot-forged into the shape of the desired individual blade unit. It is understood that other stones, irons, alloys, superalloys, ceramics and other materials and methods (e.g., stamping) well known in the art could be used in the manufacture of the blade units. In certain preferred embodiments, the blade portion will be between 2.0 and 4.0 inches in length, the tang will be between 4.0 and 8.0 inches in length and the width of the blade unit will be between 0.03 and 0.125 inches. In one particularly preferred embodiment, the blade portion will be 3.0 inches in length, the tang will be 7.0 inches in length and the width of the blade unit will be 0.06 inches. Importantly, the blade width will be sufficient to accept and hold various edge types, e.g., V(Flat) grind, convex, asymmetrical semi-convex, chisel or single bevel, and others well known in the art.

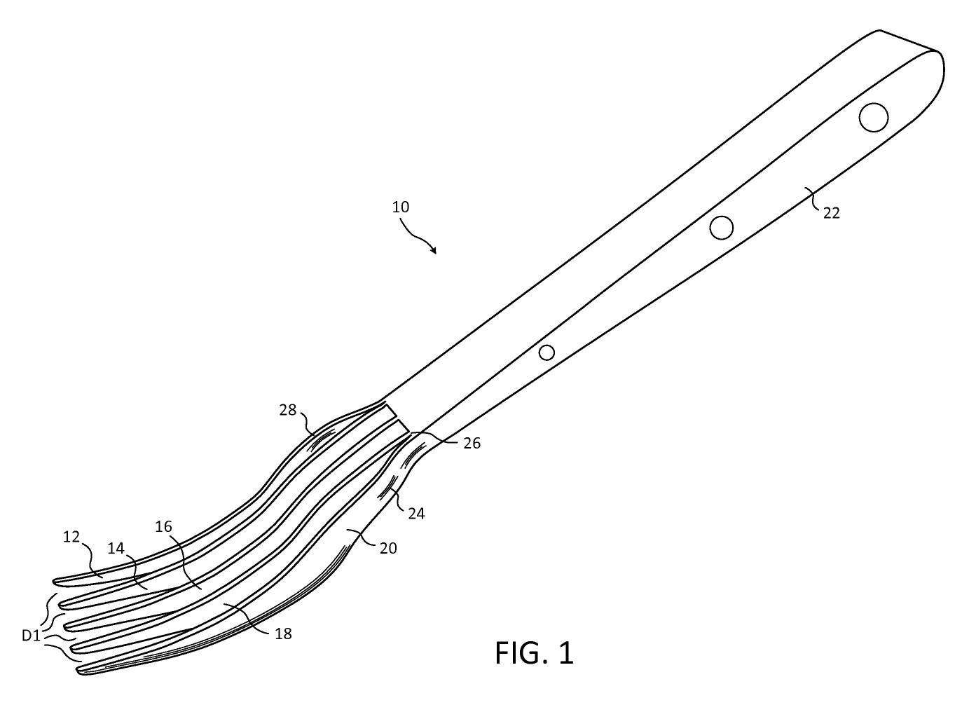

The blade units will have three alternative designs. For example, the blade units to be used as the three inner blade units of the knife will be designed such that the blade portion and the tang maintain a straight line, while the blade units intended for use as the outer blades of the knife will be designed such that there is a either a rightward or leftward convex bend applied to the blade portion at the heal end of the blade such that the blade portions project outwardly either right or left from the handle portion, thereby expanding the width of the blade portion in relation to the handle portion. The specific degree of right or left outward projection is that necessary to establish the intended desired distance between the blade units, i.e., establish the intended distance between the outer blade unit and its adjacent inner blade unit which is consistent with the distance between the other adjacent inner blade units. These alternative designs are exemplified in FIGS. 1-3.

In order to achieve the desired depth of the blades and the desired contour of the blade portion, the blade portions of the blade units of the present invention will have a preselected, precisely defined curvature along its sharpened edge created by an arch which begins at a point proximate to the blade heal and which extends the entire length of the blade to the pointed tip. The degree of curvature for the blade portions is defined herein as the distance between the pointed tip and the lowest point of the sharpened edge of the blade. This definition is exemplified in FIG. 4. Ranges of the degree of curvature contemplated for use herein range from between about 0.25 inches to about 1.5 inches, with 0.75 inches to 1.0 inch particularly preferred. The blade portions will also have an opposite, unsharpened blade back which may or may not be curved and which allows the user to place a finger(s) on the back of the blade to comfortably apply pressure on the back of the blade to facilitate mincing, slicing, dicing and chopping when desired.

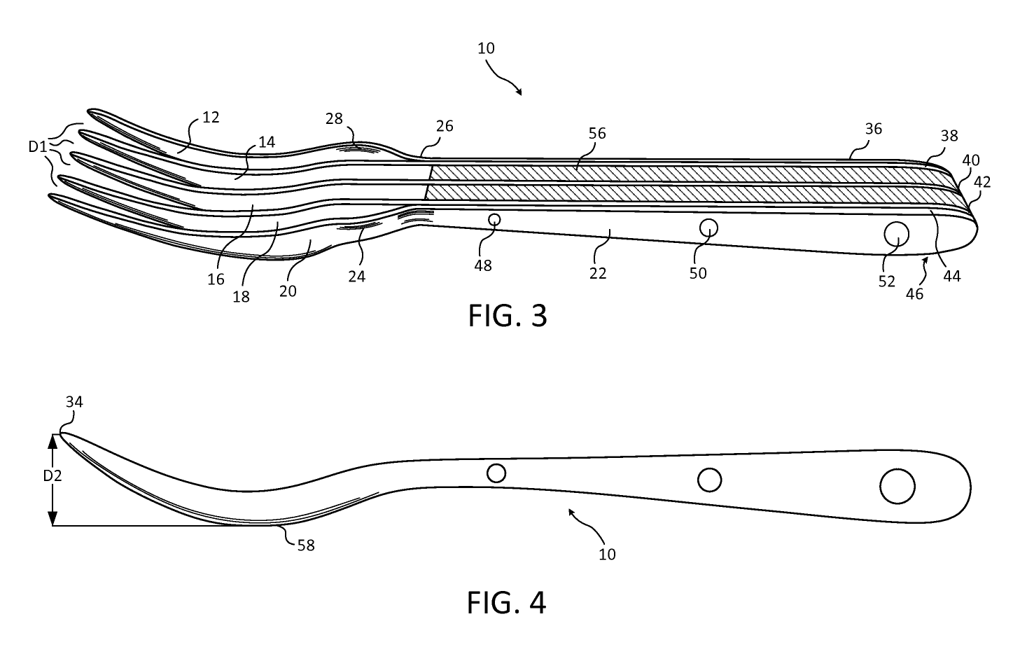

The tang portion of the blade units of the present invention will be specifically designed to interconnect with one another, and to engage and/or interconnect with a handle piece or pieces in a manner that it generally known in the art. For example, the tangs will comprise holes proximate the front and/or center and/or rear (butt) portions of the tangs and which are properly aligned such that the plurality of tangs can be interconnected by one or more rivets or screwing rods passing perpendicularly to the tangs and extending through the holes. Additionally, in order to provide the desired width of the handle portion while maintaining the desired distance between the blade units, a light weight plastic resin (or related material known in the art) will be injected into the space between the inner blades in the handle portion. This material may also have adhesive properties which also serve to mate or interconnect the plurality of tangs in addition to filling the empty space. This is exemplified in FIG. 3.

The preferred handle of the present invention will be made out of a wood, stone, plastic, rubber and other materials known in the art that are resistant to conditions of heat, dishwasher, kitchen acids and developing acids (e.g. food acids). The handle may comprise a single piece or multiple pieces having generally the same contour as the tangs and contoured to receive the fingers of a user. The length of the handle will correspond directly to the length of the tangs on the blade units to be used. The width of the handle will correspond directly to the collective widths of the tangs of the blade units to be used in the knife assembly taken in consideration with the preselected desired distance between each of the blade units. This is further exemplified in FIG. 3. The desired width of the handle may be maintained throughout the entire length of the handle, or the handle may be tapered such that the distal (butt) end of the handle has a width that is wider than that of the forward end (at the blade heal) of the handle. The distal end of the handle may also be curved.

The handle piece or pieces will be specifically designed such that it can surround and/or accept and encase the plurality of interconnected tangs in a manner that is generally known in the art. For example, in certain embodiments, the handle piece or pieces will comprise a plurality of holes that specifically align with the plurality of holes on the plurality of tangs and be secured to the plurality of tangs by one or more rivets or screw rods passing perpendicularly to the tangs/handle and extending through the holes. In instances where the handle is tapered, the lengths of the rivets or screw rods used will differ in length. Alternatively, the interconnected tangs may be inserted and then glued into a one piece handle using epoxy glue, or like adhesive material.

In FIG. 1 there is illustrated a five-blade hand held knife 10 which comprises five curved blades 12, 14, 16, 18 and 20 extending generally parallel at a first end and a handle portion 22 at a second end. Blade 20 is designed to have a leftward convex bend 24 at the heal end 26 of the blade which projects blade 20 outward from the handle portion 22. Blade 12 is designed to have a rightward convex bend 28 at the heal end 26 of the blade which projects blade 12 outward from the handle portion 22. Blades 14, 16 and 18 maintain a straight line in relation to the handle portion 22. The knife 10 is specifically designed such that the blades 12, 14, 16, 18 and 20 are equally distanced Dl in relation to another.

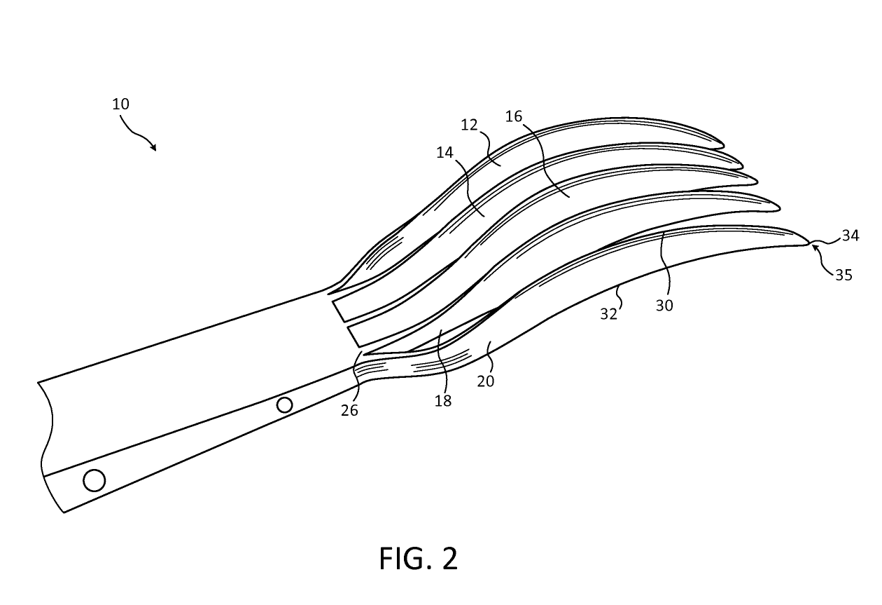

As seen in FIG. 2, in a preferred embodiment, each blade 12, 14, 16, 18 and 20 has one edge 30 which is sharpened and an opposite edge 32, referred to as the blade back, which is not sharpened. A pointed tip 34 is provided at a distal end 35 of each blade. The sharpened edge 30 of each of the five curved blades 12, 14, 16, 18 and 20 extends along the length of the blade from the pointed tip 34 at the distal end 35 of each blade to a point proximate the heal end 26 of the blades.

As seen in FIG. 3, each blade 12, 14, 16, 18 and 20 has a tang 36, 38, 40, 42 and 44 which begins at the blade heal 26 and extends to the butt end 46 of the handle portion 22. The blade 14-tang 38, blade 16-tang 40 and blade 18-tang 42 blade units are designed so as to maintain a straight line. The blade 12-tang 36 unit is designed to have a rightward convex bend 28 at the heal end 26 of the blade which projects blade 12 outward from the handle portion 22. The blade 20-tang 44 blade unit is designed to have a leftward convex bend 24 at the heal end 26 of the blades which projects blade 20 outward from the handle portion 22. The blade 20-tang 44 blade unit is interconnected directly to the blade 18-tang 42 blade unit. The blade 12-tang 36 blade unit is interconnected directly to the blade 14-tang 38 blade unit. There is a defined distance between the blade 14-tang 38 blade unit and the blade 16-tang 40 blade unit, and between the blade 16-tang 40 blade unit and the blade 18-tang 42 blade unit. This defined distance corresponds to the intended desired distance D1 between the blade units. A light weight plastic resin 56, or like material, may be injected into the empty space between the blade 14-tang 38 and blade 16-tang 40 blade units and between the blade 16-tang 40 and blade 18-tang 42 blade units within the entire length of the handle portion 22. Each tang 36, 38, 40, 42 and 44 comprises hole 48 proximate the front portion of the tang, hole 50 proximate the center portion of the tang, and hole 52 proximate its rear (butt) end. Holes 48, 50 and 52 will be used to accept rivets and or screwing rods which will pass perpendicularly to the tangs and extend through the holes so as to will interconnect the tangs 36, 38, 40, 42 and 44. Holes 48, 50 and 52 will also be used to connect a handle piece or pieces to the interconnected tangs. In such instance, the handle piece or pieces will comprise holes having the same diameter as holes 48, 50 and 52 and which are properly aligned with holes 48, 50 and 52 so as facilitate the mating of the interconnected tangs with the handle piece or pieces. During assembly, 3 inch to 5 inch rods (not shown) which are sized to pass perpendicularly to the tangs and extend through holes 48, 50 and 52 will be used to hold the knife assembly in place while the plastic resin 56 or like material is injected into the empty spaces and/or until such time that the handle piece or pieces are ready to be connected to the handle portion.

As seen in FIG. 4, the degree of curvature, D2, for the blade units is defined herein as the distance between the pointed tip 34 and the lowest point 58 of the sharpened edge of the blades 12, 14, 16, 18 and 20.

As apparent from the foregoing specification, the invention is susceptible of being embodied with various alterations and modifications which may differ from those described and exemplified in the preceding specification and description. It should be noted that the inventor wishes to embody within the scope of the patent warranted hereon all such modifications as reasonably and properly come within the scope of the teachings.

What is claimed is:

1. A five-blade hand held knife for use in slicing or chopping food items, comprising a handle and five generally parallel curved blades extending from the handle; wherein the blades have a curved sharpened edge along their length leading to a point and an opposite, unsharpened blade back; wherein the blades are equally distanced in relation to one another; and wherein the handle includes a plurality of tangs contained therein, said tangs interconnected together at forward, center and rearward portions of the handle.

2. A five-blade hand held knife for use in slicing or chopping food items, comprising a handle and five generally parallel curved blades extending from the handle; wherein the blades have a curved sharpened edge along their length leading to a point and an opposite, unsharpened blade back; and wherein the blades are equally distanced as relates to one another.
